(19) United States
(12) Patent Application Publication
(10) Pub. No.: US 2008/0317925 A1
(43) Pub. Date: Dec. 25, 2008

(54) Sugarless nougaz confectionery composition and method for making same

(76) Inventor: Mohamad Goharian, Isfahan (IR)

Correspondence Address: BARRY CHOOBIN, 193 SUITE #18, TALEGHANI, BAHARE SHOMALI, TEHRAN, 1563714311, IR

(21) Appl. No.: 12/111,983

(22) Filed: Apr. 30, 2008

(51) Int. Cl. A23L 1/236

(52) U.S. Cl. 426/548

(57) ABSTRACT

Disclosed is a sugarless nougaz confectionery composition and method for making same wherein said composition consists of: Sorbitol: 31%-35% of the entire composition by volume; Rose water: 1%-3% of the entire composition by volume; Albumen powder: 5%-8% of the entire composition by volume; and Pistachio: 20%-26% of the entire composition by volume.

### BACKGROUND OF THE INVENTION

Nougat is a term used to describe a variety of similar confectioneries made with sugar or honey, roasted nuts (almonds, walnuts, pistachios or hazelnuts are common, but not peanuts) and sometimes chopped candied fruit. The consistency of nougat can range from chewy to hard depending on its composition, and it is used in a variety of candy bars and chocolates.

There are two basic kinds of nougat: white and brown. White nougat is made with beaten egg whites and is soft, whereas brown nougat (called nougatine in French) is made with caramelized sugar and has a firmer, often crunchy texture.

Persian nougat, known as gaz, is a variety that has been produced in Isfahan, Iran for many centuries. It contains the sugary extract of the root of Tamarix. A special kind of Gaz is referred to as Nogha in Persian. Nogha is almost exclusively made with walnuts instead of pistachios & almonds which are usual for other types of Gaz. The making of Nogha is very much the same as any other Gaz. The difference is that Nogha is usually spread between two very thin layers of wafers and cut into 10×5×5 cm sections which are larger than ordinary Gaz cubes.

Gaz as a variation of nougat is a delicious sweet that originates from the city of Esfahan, located in the central plateau of Iran. Gaz is derived from the juices and stems of a desert plant called Angebin which is a member of the Tamarisk family, native to the Zagross mountain range located to the west of the city. It is commonly associated with the Manna of sacred books. This is combined with other ingredients including Pistachio or Almond kernels, Rose Water and Egg White and is recognized for its medicinal qualities.

Traditionally, the juice and stems were collected from the mountains and brought into town where copper vessels were filled with the raw mixture which was then beaten until it reached the desired consistency and fashioned by hand into its desired shape. You can still see this process in action today in Esfahan.

Nougats are perhaps the most complex and difficult of the generic confectionery bases to prepare. They are aerated confections whose density largely depends on a frappe element and texture on a syrup element along with its subsequent crystallization.

The preparation of soft confections such as nougat, involves the combination of two primary components thereof, namely high boiling syrup such as corn syrup or the like, and a relatively light textured frappe, generally prepared from gelatin, egg albumen, milk proteins such as casein, and vegetable proteins such as soy protein, and the like. The frappe is generally relatively light, and may, for example, range in density from about 0.3 to about 0.8.

By comparison, the high boiled syrup, or “bob syrup”, is relatively viscous and possesses a higher density, and frequently contains a substantial amount of sugar. Conventionally, the final nougat composition is prepared by the addition of the “bob syrup” to the frappe under agitation, to form the basic nougat mixture. Further ingredients such as flavorings, oils, additional sugar and the like may be added thereafter also under agitation. A general discussion of the composition and preparation of nougat confections may be found in B. W. Minifie, CHOCOLATE, COCOA AND CONFECTIONERY: Science and Technology, 2nd Edition, AVI Publishing Co., Inc., Westport, Conn., (1980) at Pages 424-425. Nougat formulations developed around sugar as a base are not directly applicable to the sugarless polyols because of basic differences in the physical/chemical properties of polyols relative to sucrose.

Therefore, the development of sugarless nougat technology based on sugar substitutes (e.g., polyols) will depend on the chemical characteristics of the polyols available, the ability to control the graining of sugar substitutes or simulation of grain with sugarless ingredients as well as the ability of polyols to entrap air during whipping.

A number of sugar substitutes have been developed which can be used in a confectionery composition. Of particular interest are hydrogenated starch hydrolysates which have been used as a sucrose substitute in candy and other sugar containing products and polyhydric alcohols, such as sorbitol.

The polyhydric alcohols and hydrogenated starch hydrolysates are hydroscopic and generally form candies that are unstable at elevated temperatures and high humidity. In particular, soft candies containing hydrogenated starch hydrolysates tend to become sticky and have excessive cold flow when subjected to these conditions. One method used to control this problem is to wrap the candies such that the moisture content will be kept at less than about 1%.

Hydrogenated starch hydrolystes have been used to form a gelled confection. U.S. Pat. No. 4,597,981 discloses a process for preparing a soft candy composition containing from 9% to 82% by weight hydrogenated starch hydrolysate and 82% to 9% by weight of at least one polymer of glucose or maltose, 3% to 16% by weight of gelatin and 6% to 20% water by weight to form a soft, sugar free gelled candy.

Hydrogenated starch hydrolysates have been used to form a nougat-type confection. U.S. Pat. No. 4,323,588 discloses aerated confections such as marshmallow or nougat. The product requires the proper blend of crystallized and dissolved carbohydrates in conjunction with a whipping agent. The confection contains as bulking agent and sweetener a combination of about 20% to about 90% hydrogenated starch hydrolysate and about 5% to about 60% hydrogenated sugar such as isomaltitol and preferably hydrogenated isomaltulose.

It would, therefore, be desirable to develop pleasant tasting, soft, sugarless nougat-type confections prepared with inexpensive readily available ingredients which can be formed into final shape by molding, cut and wrap or extrusion processes.

Furthermore, the present invention composition can be edible even for people with heart diseases, diabetes, obesity and healthy people, without health concerns, because it prevents different diseases.

### SUMMARY OF THE INVENTION

A sugarless, soft, chewable aerated nougat-type confection comprising from about Isomalt 30-35%, Sorbitol 31-35%, Rose-water 1-3%, Albumen powder 5-8%, Pistachio 20-26% has been unexpectedly discovered. The present invention composition can be edible even for people with heart diseases, diabetes, obesity and healthy people, without health concerns, because it prevents different diseases.

### DETAILED DESCRIPTION OF THE INVENTION

Non-infectious diseases like diabetes, heart diseases, obesity, and the death rate for this reason, on one hand, and the people desire to change the alimentary habit with the general knowledge in other hand, make a motive for the present invention. The present invention composition doesn't change the blood sugar measure, and like the usual Gaz doesn't make so many calories in the body.

In the present invention, the ingredients of sugar and glucose are replaced with isomalt.

Sorbitol isn't absorbed by blood, and its' calorie is 2/6 kcal/g. After eating sorbitol the range of it in tissues and blood is negligible and 15-20% of consumed sorbitol metabolism in the liver quickly.

Isomalt is obtained from sugar beet in a two-step process. One gram of isomalt produces two kilos of the energy of calorie and it is useful for a person who needs low energy.

Researches show that replacing isomalt with sucrose lead to decrease blood sugar and to lose weight.

The isomalt advantages:

Isomalt is a natural sugar substitute, a type of sugar alcohol, which is primarily used for its sugar-like physical properties. It has only a small impact on blood sugar levels, does not promote tooth decay, and has one half the calories of sugar. However, like most sugar alcohols, it carries a very real risk of gastric distress, including flatulence and diarrhea, when consumed in large quantities. Isomalt is typically blended with a high intensity sweetener such as sucralose, so that the mixture has approximately the sweetness of sugar.

Isomalt is a disaccharide composed of the two sugars glucose and mannitol. It is an odorless, white, crystalline substance containing about 5% water of crystallization. Isomalt has a minimal cooling effect, lower than many other sugar alcohols, particularly xylitol and erythritol. Isomalt is unusual as it is a natural sugar alcohol that is produced from beets. An interesting use of isomalt is found in the product Diabetes Sweet, a sugar substitute sold for baking use and composed of a blend of isomalt and acesulfame potassium, but it has a bitter taste (due to the acesulfame potassium) and lacks the caramelizing properties of sugar.

The necessary instruments:

A cauldron for cooking sugar-free nougaz.

A mixer for preparing Albumen powder.

A cutter-machine for shaping Nougaz.

A packing machine for wrapping Nougaz.

Ingredients:

| The raw materials: | ingredients: |
|---|---|
| Isomalt | 30-35% |
| Sorbitol | 31-35% |
| Rose-water | 1-3% |
| Albumen powder | 5-8% |
| Pistachio | 20-26% |

The method of producing comprises:

In preferred embodiment the method of producing the Nougaz comprises:

Pouring the weighing water into a large metal bowl with a rounded base used for cooking and serving food such as cauldron;

Boiling the water;

Pouring a predetermined amount of isomalt grains into the boiled water wherein said isomalt grains being solved and creates a clear liquid;

Adding sorbitol to said clear liquid;

Mixing said added sorbital with said clear liquid employing paddle wherein paddle's motion and controlled temperature leads to transformation of said liquid to a harden and evaporated composition;

Adding Albumen powder after about 4-5/5 hours (Mixing the Albumen powder, rose water and water, by mixer until it will be made a bulky shape like a sponge. In fact the first test in this time will be done. The benchmark test is a test that a liquid between two fingers will be converse to a lump-sugar thin string. And it doesn't stick to the teeth.)

Adding said sponge to said harden and evaporated composition.

Yet in another embodiment the method of producing the Nougaz further comprises;

Maintaining the motion of said paddle and maintaining the controlled temperature for about 3-4 hours, until the second test or fragile test will be done;

Pouring a predetermined amount of pistachio to said cauldron,

Mixing said amount of pistachio with said added sponge to said hardened and evaporated composition.

The temperature for the composition before adding the sponge decrease to 60 degrees.

After mixing the pistachio with said composition, the result product characterized as Nougaz, is transferred to a unit forming system, wherein said Nougaz is placed on flat mould steel and kept in a cold temperature for a long time.

After this process, Nougaz being cut to small pieces by cutter-machine and being wrapped. Next, the wrapped Nougaz will be moved to the packing unit.

Although preferred embodiments of the invention have been described in the foregoing Detailed Description, it will be understood that the invention is not limited to the embodiments disclosed, but is capable of numerous rearrangements and modifications of parts and elements without departing from the spirit of the invention. It will be understood that the chemical and/or mechanical details of every design may be slightly different or modified by one of ordinary skill in the art without departing from the teachings of the present invention.

I claim:

1. A sugarless composition for making nougaz consisting of:
Isomalt: 30%-35% of the entire composition by volume;
Sorbitol: 31%-35% of the entire composition by volume;
Rose water: 1%-3% of the entire composition by volume;
Albumen powder: 5%-8% of the entire composition by volume; and
Pistachio: 20%-26% of the entire composition by volume.

2. A composition as claimed in claim 1, wherein said album powder is in form of sponge.

3. A method for making nougaz, said method consisting of:
Pouring a predetermined amount of water into a container;
Boiling said water;
Pouring a predetermined amount of isomalt grains into the boiled water wherein said isomalt grains being solved and creates a clear liquid wherein said isomalt is 30%-35% of the entire composition by volume;
Adding sorbitol to said clear liquid wherein said sorbitol is 31%-35% of the entire composition by volume;
Mixing said added sorbital with said clear liquid employing paddle wherein paddle's motion and controlled temperature leads to transformation of said liquid to a harden and evaporated composition;
Adding albumen powder wherein said powder is in form of sponge and is 5%-8% of the entire composition by volume;
Maintaining said paddle's and maintaining the controlled temperature;
Pouring a predetermined amount of pistachio into said container wherein said predetermined amount of pistachio is 20%-26% of the entire composition by volume;
Mixing said amount of pistachio with said added sponge to said hardened and evaporated composition;
Obtaining nougaz;
Transferring said nougaz on flat mould steel;
Cutting said nougaz to small pieces; and
Wrapping said small pieces.
